(19) United States
(12) Patent Application Publication
(10) Pub. No.: US 2004/0110877 A1
(43) Pub. Date: Jun. 10, 2004

(54) Suspension comprising multiple surface active agents for treating oilfield fluids and gases and a method of making and using the same

(76) Inventor: Harold L. Becker, Tomball, TX (US)

Correspondence Address: John Wilson Jones, Attn: IP Docketing Clerk, Locke, Liddell & Sapp LLP, 600 Travis, Suite 3400, Houston, TX, 77002, US

(21) Appl. No.: 10/313,373

(22) Filed: Dec. 6, 2002

(51) Int. Cl. C08J 3/02

(52) U.S. Cl. 524/114

(57) ABSTRACT

A suspension, for use as an oilfield fluid, is composed of at least one ethylene vinyl acetate copolymer, at least one surface active agent other than an ethylene vinyl acetate copolymer and a bipolar solvent. The bipolar organic solvent has a boiling point higher than the melting point of the ethylene vinyl acetate copolymer. The polar and nonpolar groups of the bipolar organic solvent and the ethylene vinyl acetate copolymer(s) form a micellar self-assembly such that the polar groups and nonpolar groups of the ethylene vinyl acetate copolymer(s) are associated with the polar groups and nonpolar groups, respectively, of the bipolar organic solvent. The micellar self-assembly serves as a vehicle for the incorporation of the surface active agent(s) into a single multi-component blend. Suitable surface active agents include corrosion inhibitors, scale preventatives, demulfisying agents, paraffin inhibitors, gas hydrate inhibitors, flocculanting agents as well as asphaltene dispersants. The suspensions are prepared by heating and mixing a mixture comprising the surface active agents, ethylene vinyl acetate copolymer(s), and bipolar organic solvent to a temperature sufficient to solvate the ethylene vinyl acetate copolymer(s), preferably from about 280 to about 375° F. The product is then air cooled such that the ethylene vinyl acetate copolymer(s) are excluded to form the suspension.

### FIELD OF THE INVENTION

The present invention relates to suspensions containing an ethylene vinyl acetate copolymer and at least one surface active agent, a method of producing such fluid suspensions and a method of using such suspensions as oilfield fluids. The ethylene vinyl acetate copolymer may function both as a paraffin inhibitor as well as a building unit of a micellar self-assembly.

### BACKGROUND OF THE INVENTION

Oilfield fluids (e.g., oil, gas, and water) are complex mixtures of aliphatic hydrocarbons, aromatics, hetero-atomic molecules, anionic and cationic salts, acids, sands, silts, clays and a vast array of other components. The nature of these fluids combined with the severe conditions of heat, pressure, and turbulence to which they are often subjected during retrieval, result in a multitude of problems, such as scale formations, emulsification (both water-in-oil and oil-in-water), gas hydrate formation, corrosion, asphaltene precipitation, and paraffin formation. Historically, these problems have been addressed individually through the use of specifically formulated compositions containing just one surface active agent, such as a single composition containing a scale inhibitor, demulsifier, gas hydrate inhibitor, corrosion inhibitor, asphaltene dispersant, or paraffin inhibitor. See, for instance, U.S. Pat. No. 6,309,431, herein incorporated by reference, which discloses the use of winterized wax crystal modifiers to inhibit or retard the formation of wax crystal precipitates in petroleum fuel and crude oil at cold temperatures.

Products of the prior art are often applied at different points throughout the production system and require several pumps, multiple storage tanks, and a variety of entry points into the production system. Additionally, the products are formulated to be stable under the prevailing weather conditions encountered in the fields in which they are placed. This often requires that the product be diluted with solvents and thereby exhibit lower effectiveness than the more concentrated form.

Many attempts have been made to combine various surface active agents into a single composite; at best, they have been met with limited success. Most of the multiple component systems have suffered from such shortcomings as aqueous product immiscibility in organic solvents, resulting in separations. Further, the quantities of the surface active agents required for resolution of multiple problems are often vastly different. This has placed additional constraints on the successful blending of surface active components since they may only be compatible in a specific range of concentrations. Usually the solubility of one surface active component determines whether or not it will be compatible with a second surface active component and its solvent system. Early attempts at producing multiple surface active systems employed the use of multiple solvents; each of the surface active components being soluble in different solvents. This, unfortunately, added to the instability of the multi-component blend.

### SUMMARY OF THE INVENTION

Stable suspensions for use in the treatment of oilfield fluids contain:

(a.) at least one ethylene vinyl acetate copolymer;

(b.) at least one surface active agent other than an ethylene vinyl acetate copolymer; and

(c.) a bipolar organic solvent. The bipolar organic solvent has a boiling point higher than the melting point of the ethylene vinyl acetate copolymer(s) such that the ethylene vinyl acetate copolymer(s) can be solvated at elevated temperatures. The boiling point of the bipolar organic solvent is generally greater than or equal to 290° F., preferably greater than or equal to 350° F. The suspension is further void of organic solvents having a boiling point below 300° F.

Surface active agents suitable for inclusion in the stable suspension of the invention include demulsifying agents, corrosion inhibitors, scale inhibitors, paraffin inhibitors, gas hydrate inhibitors, flocculating agents and asphaltene dispersants. Especially preferred are demulsifying agents, corrosion inhibitors, scale inhibitors, gas hydrate inhibitors, flocculating agents and asphaltene dispersants.

Suitable as the bipolar organic solvents are acylated alcohols (such as acylated monohydric C₃-C₈ alcohols), glycol ethers, glycol ether esters as well as alkoxylated alcohols (such as the reaction product of a monohydric C₃-C₈ alcohol and alkylene oxide).

The combination of the bipolar organic solvent and ethylene vinyl acetate copolymer(s) forms a micellar self-assembly such that the polar groups of the bipolar organic solvent and ethylene vinyl acetate copolymer(s) are associated with each other and the non-polar groups of the bipolar organic solvent and ethylene vinyl acetate copolymer(s) are associated with each other. The at least one surface active agent is incorporated into the micellar self-assembly.

Such suspensions are prepared by heating and mixing the surface active agent(s), ethylene vinyl acetate copolymer(s), and bipolar organic solvent to a temperature sufficient to solvate the ethylene vinyl acetate copolymer(s), typically between from about 280 to about 375° F. Those components having a lower boiling point are removed as distillate. The temperature is then lowered to a suitable temperature to form a suspension, generally between from about 250 to about 270° F. Prior to or during cooling, a highly polar organic solvent may be added to the mixture to assist in the formation of the suspension.

### DETAILED DESCRIPTION OF PREFERRED EMBODIMENTS

The suspensions of the invention contain at least one surface active agent in addition to the ethylene vinyl acetate copolymer. Any surface active agent known in the art to treat oilfield liquids and gases may be used.

As such, the suspensions of the invention may be used for a multitude of purposes such as the resolution of emulsions, retardation of corrosion, inhibition of scale formation, dispersing asphaltenes, inhibition of paraffin crystal formation, and interference with gas hydrate formations. A single suspension can be used for one or all of these purposes.

The inventive suspension eliminates solution incompatibility differences seen in the prior art. Such incompatibility differences has, in the past, made it virtually impossible to combine more than one surface active agent into one formulation.

The multi-component suspensions of the invention can be tailored to the needs of a particular location. In addition, they also can be used to reduce the need for multiple storage locations, reduce production costs, and lower the costs of freight. The resulting suspensions exhibit highly desirable properties, such as low pour points (for use of the suspensions in cold climates) as well as excellent heat stability (for use of the suspensions in hot climates). Pour point is defined by ASTM D-97 as “the lowest temperature at which the crude oil will still flow when it is held in a pour point tube at ninety degrees to the upright for five seconds.” The suspensions of the invention can exhibit a pour point lower than −40° F.

The surface active agents which may be incorporated into the suspension of the invention include those having polar as well as non-polar groups. In addition, charged or uncharged surface active agents may be employed. In a preferred embodiment, the suspension contains mixtures of from two to nine surface active agents.

Surface active agents suitable for inclusion in the stable suspension of the invention include demulsifying agents, corrosion inhibitors, scale inhibitors, paraffin inhibitors, gas hydrate inhibitors, flocculating agents and asphaltene dispersants. Any chemical species known in the art for use as such agents may be employed.

Exemplary of the demulsifying agents that are useful include, but are not limited to, condensation polymers of alkylene oxides and glycols, such as ethylene oxide and propylene oxide condensation polymers of di-propylene glycol as well as trimethylol propane; and alkyl substituted phenol formaldehyde resins, bis-phenyl diepoxides, and esters and diesters of the such di-functional products. Especially preferred as non-ionic demulsifiers are oxyalkylated phenol formaldehyde resins, oxyalkylated amines and polyamines, di-epoxidized oxyalkylated polyethers, etc. Suitable oil-in-water demulsifiers include poly triethanolamine methyl chloride quaternary, melamine acid colloid, aminomethylated polyacrylamide etc.

Paraffin inhibitors useful for the practice of the present invention include, but are not limited to, ethylene/vinyl acetate copolymers, acrylates (such as polyacrylate esters and methacrylate esters of fatty alcohols), and olefin/maleic esters. The at least one surface active agent may be an ethylene vinyl acetate copolymer such that the composition contains greater than one ethylene vinyl acetate copolymer. Other components capable of functioning as crystal modifiers for paraffin wax may also be used.

Corrosion chemicals that are useful for the practice of the present invention include but are not limited to fatty imidazolines, alkyl pyridines, alkyl pyridine quaternaries, fatty amine quaternaries and phosphate salts of fatty imidazolines.

Scale inhibitors that are useful for the practice of the present invention include but are not limited to sulfate, and phosphate esters (especially phosphate esters of mono, di, and triethanolamine), polyacrylics and phosphonamides.

Gas hydrate treating chemicals or inhibitors that are useful for the practice of the present invention include but are not limited to polymers and homopolymers and copolymers of vinyl pyrrolidone, vinyl caprolactam.

Asphaltene treating chemicals that are useful for the practice of the present invention include but are not limited to fatty ester homopolymers and copolymers (such as fatty esters of acrylic and methacrylic acid polymers and copolymers) and sorbitan monooleate.

Water clarifier chemicals that are useful for the practice of the present invention include flocculating agents. Exemplary species include, but are not limited to, homopolymers and copolymers of acrylamide and aminomethylated polyacrylamides (such as di-methylaminopropyl methacrylamide and di-methylaminopropyl acrylamide), poly-triethanolamine ethers, salts of poly-triethanolamine ethers, melamine acid colloids, methyl esters of poly-sodium acrylate, and crosslinked polyamines.

In addition to containing a multitude of surface active agents, the stable suspensions of the invention further include a bipolar organic solvent. The bipolar organic solvent preferably has a boiling point over about 290° F., preferably greater than 350° F. The ethylene vinyl acetate copolymer is suspended in the bipolar organic solvent. The suspension is further preferably void of organic solvents having a boiling point below 300° F.

Suitable as the bipolar organic solvents are alcohols, alkoxylated alcohols (such as alkoxylated monohydric C₃-C₈ alcohols with an alkylene oxide), acylated alcohols (such as acylated monohydric C₃-C₈ alcohols), glycol ethers, and glycol ether esters. Preferred bipolar solvents include C₃-C₁₆ alcohols and/or ethoxylated alcohols possessing up to about six ethylene oxide residues, and C₂-C₁₀ esters of mono-, di-, and tri-glycol ethers. More preferred bipolar solvents include ethoxylated monohydric alcohols such as ALFONIC 6-3 (C₆ normal monohydric alcohol condensed with 3 moles of ethylene oxide, commercially available from Vista Chemical Company), ALFONIC 810-2 (C₈-C₁₀ mixed normal monohydric alcohol condensed with 2 moles of ethylene oxide, commercially available from Vista Chemical Company), EXATE-600 (an acylated monohydric C₆ alcohol), and ethylene glycol dibutyl ether and mixtures thereof.

For example, the bipolar solvent may consist of polar (such as ethylene oxide adducts of linear alcohol) and non-polar (such as aliphatic alkyl groups) groups are generally used to dissolve the ethylene vinyl acetate copolymer(s). Typically, the mixture of bipolar solvent and ethylene vinyl acetate copolymer is heated with mixing to a temperature above the melting point of the ethylene vinyl acetate copolymer to effect its dissolution.

The polar acetate groups of the ethylene vinyl acetate copolymer associate with the polar groups of the bipolar organic solvent, thereby solvating the ethylene vinyl acetate copolymer. The combination of bipolar organic solvent and ethylene vinyl acetate copolymer provides a strong impetus for self-assembly at elevated temperatures such that polar groups are aligned with similar polar groups and non-polar groups with similar non-polar groups.

Thus, it is believed that when the ethylene vinyl acetate copolymer(s) are mixed with the bipolar solvent, the polar (vinyl acetate) segments of the ethylene vinyl acetate copolymer associate with the polar segments of the bipolar solvent. This association is commonly referred to as micellarization, or the formation of particles of sufficiently small size to produce a stable suspension of solid polymer within a non-solvent or poorly solvating external fluid.

It should be noted that the ethylene vinyl acetate copolymer, in addition to potentially serving as a paraffin inhibitor, further performs a role in micellarization. In the present invention the process of “micellarization” is recognized as a special case of self-assembly such that several surface-active components can be incorporated into the end product suspensions. The ethylene vinyl acetate copolymers of the invention may possess ratios of vinyl acetate to ethylene from about 10:90 to about 50:50, preferably from about 20:80 to about 40:60. The molecular weights of the copolymers may generally be from about 10,000 to about 100,000, preferably from about 30,000 to about 50,000.

Further, the surface active agent(s) are believed to align themselves by polarity. In other words, the polar portions of the surface active agents are believed to be aligned with the polar groups of the bipolar groups of the micellar self-assembly; the non-polar groups of the surface active agent(s) are believed to be aligned with the non-polar groups of the ethylene vinyl acetate copolymer and bipolar organic solvent. Where the surface active agent(s) are reduced to solid by solvent stripping, it is believed that the surface active agent(s) are enveloped by the solidifying ethylene vinyl acetate copolymer as the mixture cools.

Such suspensions are prepared by heating and mixing a mixture comprising the surface active agents, ethylene vinyl acetate copolymer, and bipolar organic solvent until the ethylene vinyl acetate copolymer is solvated. Generally, the mixtures are heated to a temperature between from about 280 to about 375° F. (The temperature is often preferred to be greater than 340° F. because some of the higher melting ethylene/vinyl acetate copolymers do not become solvated until such high temperatures are obtained.) Solvents having a lower boiling point are removed as distillate.

An essential aspect of the procedure involves the distillation of lower boiling incompatible solvents typically formulated (e.g., water, isopropyl alcohol, and methanol) typically formulated, thus leaving the active components as either solids or highly active liquids that are incorporated into the solidifying ethylene vinyl acetate copolymer. Such lower boiling incompatible solvents often form the diluent or the liquid media for the surface active agent.

The distillate is removed from the mixture and the temperature is lowered, typically from about 250 to about 270° F., in order to exclude the ethylene vinyl acetate copolymer(s). The resulting suspension is composed of finely divided suspensoids of the ethylene vinyl acetate copolymer(s). The resulting mixture is then allowed to cool to ambient temperature with vigorous mixing.

A polar organic solvent, preferably having a boiling point higher than 270° F., may be added to the mixture prior to or during cooling. The suspension formed is stable at ambient temperatures.

Surface-active molecules, such as those described above, are thought to aggregate into macro assemblies because of their make-up of variable polarity and these aggregations can be thought of as self-assembled. The present invention utilizes this self-assembly tendency to develop multi-component mixture of surface-active molecules within a unique solvent polymer matrix. The mixture undergoes solvation of the ethylene vinyl acetate copolymer at elevated temperatures and excludes the copolymer from solution at low temperature to form the finely divided copolymer suspension.

As such, the present invention utilizes the solvency properties of the bipolar organic solvent to the ethylene vinyl acetate copolymer to incorporate the several surface-active chemicals (e.g., demulsifiers, corrosion inhibitors, paraffin inhibitors, gas hydrate inhibitors, water clarifiers, flocculants, scale inhibitors, and asphaltene dispersants) into the copolymer as it is excluded from solution at low temperature.

In a preferred embodiment, the mixture is heated to from about 320 to about 340° F. with vigorous mixing, and the lower boiling solvent fractions are collected into a decanter for recycling. After the lower boiling solvents have been removed and the mixing at from about 320 to about 340° F. has been maintained for about 30 to about 40 minutes, the system is preferably allowed to air cool to from about 260 to about 280° F. The ethylene/vinyl acetate copolymer acts as orientation sites for the self assemblies and as the system is cooled back, the system is locked into place by the solidifying polymer. In this way even highly polar ionic materials can be incorporated into the forming ethylene/vinyl acetate polymer and become a stable suspension.

The high polarity solvent may be added to the mixture of ethylene vinyl acetate copolymer and bipolar solvent during the cooling phase to develop the suspension. Alternatively, the high polarity solvent may be formed with the initial mixture of ethylene vinyl acetate copolymer, surface active agent(s) and bipolar organic solvent. The use of high polarity solvents is not, however, required.

High polarity solvents that may be used to develop the polymeric suspension by increasing the inter-particle distance and density of the blend include but are not limited to diethylene glycol, butanol, isobutanol, 2-ethyl hexanol, butyl carbitol and butyl cellosolve. In a preferred embodiment, the high polarity solvent is 2-ethyl hexanol. Diethylene glycol is the most preferred high polarity solvent where the bipolar organic solvent is an ethoxylated monohydric alcohol. The selection of the appropriate high polarity solvent will often depend on the solubility parameters, hydrogen bonded characteristics, and densities of the desired surface active agents in the suspension.

When added during the cooling phase, the high polarity solvent is typically added once the temperature of the mixture is lowered, generally to between about 80 to about 280° F. After the high polarity solvent has been added, vigorous mixing continues and air-cooling continues while the self-assembly system and a stable suspension forms. Further, the high polarity solvent(s) may serve to separate the resulting micellar system or particle suspension such that the micellar mixture remains as a stable suspension.

The selection of bipolar and high polarity solvents useful in the present invention is aided by the use of published solubility parameter, hydrogen bonding, and density values for many commercially available solvents (e.g., CRC Handbook of Chemistry and Physics). It is assumed that these properties are additive and that specific or targeted solubility parameter, hydrogen bonding, and density values can be approximately calculated to produce a solvent mixture suitable for the formation of a stable suspension. Solubility plots are created by blending polymers with various solvents and plotting solubility parameters versus hydrogen bonding and density values. Since the formation of stable ethylene vinyl acetate copolymer suspensions is the goal, the solubility parameter, hydrogen bonding, and density values must fall outside the solubility range of the ethylene vinyl acetate copolymer. One may predict where the areas of insolubility occur by multiplying the individual solvent component's solubility parameter, hydrogen bonding, and density values by their fractional weight composition within the mixture and summing the resulting products to obtain approximate values for the mixtures, the objective being to produce a solvent mixture that possesses the appropriate solubility parameter and hydrogen bonding values to place the copolymer outside its area of solubility, while achieving a mixture density capable of producing a stable suspension.

In general, about 2 to about 40, preferably from about 5 to about 25, weight percent of the ethylene vinyl acetate copolymer is dissolved in about 5 to about 75, preferably from about 5 to about 50, weight percent of the bipolar solvent. To the mixture is further added the surface active agent(s). Typically, the amount of surface active agent(s) in the composition is between from about 0.50 to about 18 weight percent. The amount of surface active agent(s) added to the mixture is dependent upon the needs and specifications of the end user. For instance, the amount of demulsifier added to the mixture of ethylene vinyl acetate copolymer and bipolar solvent may be from 4.0 to about 18 weight percent, the amount of clarifier, hydrate inhibitor and scale inhibitor between from about 0.35 to about 18.0 weight percent and the amount of corrosion inhibitor, asphaltene dispersent between from about 8.0 to about 15.0 weight percentscale.

In a more preferred embodiment, about 10 to about 25 weight percent of the ethylene vinyl acetate copolymer is dissolved in about 35 to about 50 weight percent of the bipolar solvent. In a more preferred embodiment, about 15 to about 25 weight percent of the ethylene vinyl acetate copolymer is dissolved in about 40 to about 50 weight percent of the bipolar solvent. Once the ethylene vinyl acetate copolymer has been dissolved in the bipolar solvent at elevated temperatures, the mixture of ethylene vinyl acetate copolymer and bipolar solvent is allowed to cool to ambient temperature with vigorous mixing. When a high polarity solvent is used, typically about 2 to about 50 weight percent of high polarity solvent is added. In a preferred embodiment, about 25 to about 45 weight percent of high polarity solvent is added, and in a more preferred embodiment, about 30 to about 45 weight percent of high polarity solvent is added. The ethylene vinyl acetate copolymer in this embodiment functions as both paraffin inhibitor and as an active site for micellarization.

The following non-limiting examples, and comparative demonstrations, bring out the more salient features of this invention. All parts are given in terms of weight units except as may otherwise be indicated.

### EXAMPLES

### Example 1

A mixture comprising 3.82% weight ELVAX 150, 3.82% weight ELVAX 170, and 3.82% weight ELVAX 450 (ethylene vinyl acetate copolymers, commercially available from DuPont) 10.19% weight Sepaflux 3245 (poly-propoxylated/ethoxylated bis-phenol-diepoxide condensate polymeric demulsifier, commercially available from BASF), 2.6% JLB-301 (poly-triethanolamine methyl chloride quaternary water clarifier, commercially available from Corsicana Chemical Company), 1.94% BURCO imidazoline (imidazoline corrosion inhibitor, commercially available from Burlington Chemical Company), 0.69% weight TH-7806 (phosphate scale inhibitor, commercially available from BJ Services Unichem), 21.87% weight EXXATE-600 (acylated monohydric alcohol solvent, commercially available from Exxon Chemical Company), 51.23% 2-ethyl hexanol (alcohol solvent, commercially available from several commercial sources). The entire blend excluding the 2-ethyl hexanol is heated to 320-340° F., rapidly mixed while distilling over the lower boiling components (e.g., water from the JLB-301) into a decanter. The temperature of the blend was dropped to 270° F. and the 2-ethyl hexanol rapidly added. Once the 2-ethyl hexanol was added the mixture was allowed to air-cool with rapid mixing to form the suspended product.

Performance tests were performed on the final blend to check if the product was capable of resolving emulsions, and paraffin crystal inhibition. The product resolved a 50% volume water-in-oil emulsion within 1 hour at 150° F., and lowered the pour point of a crude oil from 40° F. to −40° F. at 100 ppm. The product was found to pour at 30° F., and did not degrade after 7 days exposed to a temperature of 140° F.

### Example 2

A mixture comprising 5.55% weight ELVAX 150, 5.55% weight ELVAX 170, and 5.55% weight ELVAX 450 (ethylene vinyl acetate copolymers, commercially available from DuPont) 6.22% weight Sepaflux 3245 (poly-propoxylated/ethoxylated bis-phenol-diepoxide condensate polymeric demulsifier, commercially available from BASF), 1.29% weight JLB-301 (poly-triethanolamine methyl chloride quaternary water clarifier, commercially available from Corsicana Chemical Company), 11.66% weight Alfa 1018 (alkyl pyridine quaternary corrosion inhibitor, commercially available from Alfa Chemical Company), 0.69% TH-789 phosphate scale inhibitor, commercially available from BJ Services Unichem), 10.37% Sorbitan Monooleate (asphaltene dispersent, commercially available from ICI Chemical Company), 17.13% weight EXXATE-600 (acylated monohydric alcohol solvent, commercially available from Exxon Chemical Company) 14.88% glycol dibutyl ether (commercially available from DuPont) 34.29% 2-ethyl hexanol (alcohol solvent, commercially available from several commercial sources). The entire blend excluding the 2-ethyl hexanol is heated to 320-340° F., rapidly mixed while distilling over the lower boiling components into a decanter. The temperature of the blend was dropped to 270° F. and the 2-ethyl hexanol rapidly added. Once the 2-ethyl hexanol was added the mixture was allowed to air-cool with rapid mixing to form the suspended product.

Performance tests were conducted on the final blend to check if the product was capable of resolving emulsions, and paraffin crystal inhibition, water clarification, and corrosion inhibition. The product resolved a 50% volume water-in-oil emulsion within 90 minutes at 150° F., and lowered the pour point of a crude oil from 40° F. to −30° F. at 100 ppm. Electrochemical corrosion tests showed that the product gave 4 MPY vs. the single component imidazoline gave 0.5 MPY. The product was found to pour at −40° F., and did not degrade after 7 days exposed to a temperature of 140° F.

### Example 3

A mixture comprising 1.73% weight ELVAX 150, 1.73% weight ELVAX 170, and 1.73% weight ELVAX 450 (ethylene vinyl acetate copolymers, commercially available from DuPont) 14.81% weight Sepaflux 3245 (poly-propoxylated/ethoxylated bis-phenol-diepoxide condensate polymeric demulsifier, commercially available from BASF), 22.22% weight EXXATE-600 (acylated monohydric alcohol solvent, commercially available from Exxon Chemical Company) 9.25% glycol dibutyl ether (commercially available from DuPont) 37.04% 2-ethyl hexanol (solvent, commercially available from several commercial sources). The entire blend excluding the 2-ethyl hexanol is heated to 320-340° F., rapidly mixed while distilling over the lower boiling components into a decanter. The temperature of the blend was dropped to 270° F. and the 2-ethyl hexanol rapidly added. Once the 2-ethyl hexanol was added the mixture was allowed to air-cool with rapid mixing to form the suspended product.

Performance tests were conducted on the final blend to check if the product was capable of resolving emulsions, and paraffin crystal inhibition. The product resolved a 50% volume water-in-oil emulsion within 45 minutes at 150° F., and lowered the pour point of a crude oil from 40° F. to −40° F. at 400 ppm. The product was found to pour at 50° F., and did not degrade after 7 days exposed to a temperature of 140° F.

### Example 4

A mixture comprising 1.67% weight ELVAX 150, 1.67% weight ELVAX 170, and 1.67% weight ELVAX 450 (ethylene vinyl acetate copolymers, commercially available from DuPont) 3.16% weight Sepaflux 3245 (poly-propoxylated/ethoxylated bis-phenol-diepoxide condensate polymeric demulsifier, commercially available from BASF), 1.58% weight DPG-40 (poly-propoxylated/ethoxylated demulsifier, commercially available from WITCO Chemical Company), 1.58% DRC-168 (nonyl-phenol formaldehyde resin propoxylated/ethoxylated demulsifier, commercially available from WITCO Chemical Company), 1.35% weight poly-behenyl acrylate (behenyl acrylate homopolymer paraffin crystal modifier, commercially available from Ciba Chemical Company), 4.74% XC-2082 (fatty imidazoline corrosion inhibitor, commercially available from Corsicana Chemical Company), 0.95% weight Alfa 1018 (alkyl pyridine quaternary corrosion inhibitor, commercially available from Alfa Chemical Company), 0.527% ACP-1199 (polyvinyl caprolactam methane hydrate inhibitor, commercially available from ICI Chemical Company), 21.25% Afloc Hib 1613 (polyacrylate asphaltene dispersent, commercially available from Shreive Chemical Company), 0.43% JLB-301 (poly-triethanolamine methyl chloride quaternary water clarifier, commercially available from Corsicana Chemical Company), 0.07% TH-789 (phosphate scale inhibitor, commercially available from BJ Services Unichem), 20.21% weight EXXATE-600 (acylated monohydric alcohol solvent, commercially available from Exxon Chemical Company) 18.77% glycol dibutyl ether (commercially available from DuPont) 21.01% 2-ethyl hexanol (alcohol solvent, commercially available from several commercial sources). The entire blend excluding the 2-ethyl hexanol is heated to 320-340° F., rapidly mixed while distilling over the lower boiling components into a decanter. The temperature of the blend was dropped to 270° F. and the 2-ethyl hexanol rapidly added. Once the 2-ethyl hexanol was added the mixture was allowed to air-cool with rapid mixing to form the suspended product.

Performance tests were conducted on the final blend to check if the product was capable of resolving emulsions, and paraffin crystal inhibition. The product resolved a 50% volume water-in-oil emulsion within 75 minutes at 150° F., and lowered the pour point of a crude oil from 40° F. to −40° F. at 600 ppm. The product was found to pour at 10° F., and did not degrade after 7 days exposed to a temperature of 140° F.

From the foregoing, it will be observed that numerous variations and modifications may be effected without departing from the true spirit and scope of the novel concepts of the invention.

What is claimed is:

1. A suspension for use in the treatment of oilfield fluids, wherein the suspension comprises:
(a.) at least one ethylene vinyl acetate copolymer;
(b.) at least one surface active agent other than an ethylene vinyl acetate copolymer; and
(c.) a bipolar organic solvent having a boiling point higher than the melting point of the at least one ethylene vinyl acetate copolymer such that the at least one ethylene vinyl acetate copolymer is capable of being solvated by the bipolar organic solvent
wherein the polar and nonpolar groups of the bipolar organic solvent and ethylene vinyl acetate copolymer form a micellar self-assembly and further wherein the at one surface active agent is incorporated into the micellar self-assembly.

2. The suspension of claim 1, wherein the polar and non-polar groups of the at least one surface active agent are aligned with the polar and non-polar groups of the micellar self-assembly.

3. The suspension of claim 1, wherein the at least one surface active agent is selected from the group consisting of demulsifying agents, corrosion inhibitors, scale inhibitors, paraffin inhibitors, gas hydrate inhibitors, flocculating agents and asphaltene dispersants.

4. The suspension of claim 3, wherein the demulsifying agent is an oil-in-water demulsifier.

5. The suspension of claim 3, wherein the at least one surface active agent is selected from demulsifying agents, corrosion inhibitors, scale inhibitors, gas hydrate inhibitors, flocculating agents and asphaltene dispersants.

6. The suspension of claim 1, wherein the bipolar organic solvent is an alkoxylated alcohol, an acylated alcohol, a glycol ether, or a glycol ether ester.

7. The suspension of claim 6, wherein the alkoxylated alcohol is a reaction product of a C₃-C₈ alcohol and an alkylene oxide.

8. The suspension of claim 7, wherein the alkyoxlyated alcohol is a reaction product of a C₆ monohydric alcohol and 2 to 3 moles of ethylene oxide.

9. The suspension of claim 6, wherein the glycol ether is ethylene glycol dibutyl ether.

10. The suspension of claim 6, wherein the acylated alcohol is an acylated monohydric C₃-C₈ alcohol.

11. The suspension of claim 1, further comprising a polar organic solvent.

12. The suspension of claim 11, wherein the polar organic solvent is selected from diethylene glycol, butanol, isobutanol, 2-ethyl hexanol, butyl carbitol or butyl cellosolve or a mixture thereof.

13. The suspension of claim 1, wherein the suspension is void of an organic solvent having a boiling point below 300° F.

14. The suspension of claim 1, wherein the suspension has a pour point, ASTM D-97, lower than −20° F.

15. The suspension of claim 14, wherein the suspension has a pour point, ASTM D-97, lower than −40° F.

16. A method of incorporating at least two surface active agents into a single suspension comprising:
(a.) forming a mixture of at least one ethylene vinyl acetate copolymer, at least one surface active agent other than an ethylene vinyl acetate copolymer and a bipolar organic solvent and heating the mixture for a time and at a temperature sufficient to solvate the at least one ethylene vinyl acetate copolymer and distilling from the mixture those components having a lower boiling point;
(b.) air cooling the product of step (a) at a temperature and for a time sufficient to exclude the at least one ethylene vinyl acetate copolymer so as to form an ethylene vinyl acetate copolymer suspension.

17. The method of claim 16, wherein the at least one surface active agent is selected from the group consisting of demulsifying agents, corrosion inhibitors, scale inhibitors, paraffin inhibitors, gas hydrate inhibitors, flocculating agents and asphaltene dispersants.

18. The method of claim 17, wherein the at least one surface active agent is selected from the group consisting of demulsifying agents, corrosion inhibitors, scale inhibitors, gas hydrate inhibitors, flocculating agents and asphaltene dispersants.

19. The method of claim 18, wherein the demulsifying agent is an oil-in-water demulsifier.

20. The method of claim 16, wherein the bipolar organic solvent is an acylated alcohol, a glycol ether or an alkoxylated alcohol with an alkylene oxide.

21. The method of claim 20, wherein the alkoxylated alcohol is a C₃-C₈ alcohol and ethylene oxide.

22. The method of claim 21, wherein the alkyoxlyated alcohol is a reaction product of a C₆ monohydric alcohol and ethylene oxide.

23. The method of claim 20, wherein the glycol ether is ethylene glycol dibutyl ether.

24. The method of claim 20, wherein the acylated alcohol is an acylated monohydric C₃-C₈ alcohol.

25. The method of claim 24, wherein the acylated alcohol is an acylated C₆ alcohol.

26. The method of claim 17, further comprising adding a polar organic solvent to the product of step (a) prior to or during air cooling.

27. The method of claim 26, wherein the polar organic solvent is diethylene glycol, butanol, isobutanol, 2-ethyl hexanol, butyl carbitol or butyl cellosolve or a mixture thereof.

28. The method of claim 27, wherein the polar organic solvent is 2-ethyl hexanol.

29. The method of claim 16, wherein the polar and nonpolar groups of the bipolar organic solvent and the at least one ethylene vinyl acetate copolymer form a micellar self-assembly and further wherein the at least one surface active agent is incorporated into the micellar self-assembly.

30. A method of treating an oilfield fluid which comprises subjecting to the fluid a liquid composition derived from the suspension of claim 1.
